(19) United States
(12) Patent Application Publication
(10) Pub. No.: US 2019/0343055 A1
(43) Pub. Date: Nov. 14, 2019

(54) CONTAINER FOR HYDROPONIC CULTURE, COVER FOR HYDROPONIC CULTURE, HYDROPONIC CULTURE APPARATUS, AND HYDROPONIC CULTURE METHOD

(71) Applicant: SEKISUI CHEMICAL CO., LTD., Osaka (JP)

(72) Inventors: Motohiro SAKAKIBARA, Tsukuba-shi (JP); Akiko TOGI, Tsukuba-shi (JP); Naoki NISHIGUCHI, Kyoto (JP); Seigo ONO, Tsukuba-shi (JP); Hiroaki GOTOU, Tsukuba-shi (JP)

(73) Assignee: SEKISUI CHEMICAL CO., LTD., Osaka (JP)

(21) Appl. No.: 16/475,779

(22) PCT Filed: Feb. 2, 2018
(86) PCT No.: PCT/JP2018/003604

§ 371 Date: Jul. 3, 2019

(30) Foreign Application Priority Data
Feb. 2, 2017 (JP) 2017-017879
Feb. 2, 2017 (JP) 2017-017880
Feb. 2, 2017 (JP) 2017-017881

(51) Int. Cl. A01G 31/02; A01G 9/02; A01G 27/00

(52) U.S. Cl. CPC A01G 31/02; A01G 27/008; A01G 27/003; A01G 9/02

(57) ABSTRACT

The hydroponic cultivation apparatus (1) of the present invention includes a container (10), a cover (50), a nutrient solution supply unit (20) for supplying a nutrient solution (W) to a hollow portion (12s) of the container (10), and a water level adjuster (60). The container (10) is formed in a tubular shape. The cover (50) has a size such that the cover (50) can protect rhizosphere (R) and cover the opening (14) of the container (10). The water level adjuster (60) is connected to the container (10) and enables adjustment of the water level of the nutrient solution (W) in the hollow portion (12s).

### TECHNICAL FIELD

The present invention relates to a hydroponic cultivation container, a hydroponic cultivation cover, a hydroponic cultivation apparatus, and a hydroponic cultivation method.

Priorities are claimed on Japanese Patent Application Nos. 2017-017879, 2017-017880 and 2017-017881, each filed Feb. 2, 2017, the contents of which are incorporated herein by reference.

### BACKGROUND ART

As methods for growing plants such as vegetables, there are outdoor cultivation to grow plants with natural environment and soil, and nutrient solution cultivation to grow plants by controlling cultivation environments so as to supply nutrients necessary for growth in the form of a nutrient solution. Particularly, the cultivation method which does not use soil among the methods for the nutrient solution cultivation is called hydroponic cultivation (hydroponics). Hydroponic cultivation has the advantage that plants can be produced irrespective of the season by optimizing the cultivation environment such as light, temperature, nutrient volume, etc. while supplying the plants with nutrients necessary for plant growth. Various studies have been made on techniques for hydroponics such as the methods of controlling light, temperature, and nutrient content in cultivation environment. At present, in many cases, hydroponics is carried out indoors, for example, in a greenhouse, but the plant cultivation carried out while constantly maintaining optimal indoor cultivation environment requires labor and cost, which makes outdoor hydroponics more desirable.

For example, Patent Document 1 discloses a hydroponic cultivation apparatus using U-shaped gutters made of concrete. In the hydroponic cultivation apparatus of Patent Document 1, U-shaped gutters made of concrete are aligned straight. A water impermeable plastic sheet is laid on the inner surface of each U-shaped gutter over its entire length, and a space inside the sheet is divided into compartments along the longitudinal direction of the U-shaped gutters by leakage preventing plates made of concrete. Plants are placed in each of the compartments.

### PRIOR ART REFERENCES

### Patent Document

Patent Document 1: Japanese Unexamined Patent Application Publication No. Hei 6-233635

### SUMMARY OF THE INVENTION

### Problems to be Solved by the Invention

However, the hydroponic cultivation apparatus described in Patent Document 1 has problems due to the use of U-shaped gutters made of concrete. Specifically, the weight of the hydroponic cultivation container in this patent document is large, whereby the installation of the hydroponic cultivation apparatus requires considerable labor, and it is difficult to flexibly change the configuration of the hydroponic cultivation apparatus. Further, regarding conventional hydroponics, no example is known where hydroponics is performed outdoors using a hydroponic cultivation apparatus which has a simple structure, and is easy to manufacture, easy to handle, and easy to be altered in its configuration. In addition, conventionally, sufficient consideration has not been made on hydroponic cultivation containers, hydroponic cultivation covers, hydroponic cultivation apparatuses, and hydroponic cultivation methods to be used for outdoor hydroponics.

In hydroponics, it is desirable to pay due care to shield the rhizosphere of plants from light and to prevent rainwater and soil from intruding into the rhizosphere. In the hydroponic cultivation apparatus described in Patent Document 1, a plastic film is installed to form an arch shape above the concrete lid in order to prevent rainwater and soil from entering the rhizosphere. Further, a reflective or light-shielding plate described in Patent Document 1 also plays a role of shielding the rhizosphere from light and preventing rainwater and soil from entering the rhizosphere. However, there is a problem that the installation of the plastic film or the reflective or light-shielding plate involves difficulties since the installation requires attention so as not to damage the stems of the plants. Further, there is a problem that an attempt to provide sufficient clearance around the plants so as not to damage the stems of plants may result in insufficient effect of shielding the rhizosphere from light and preventing rainwater and soil from entering the rhizosphere.

Furthermore, in hydroponics, it is important to adjust the water level of nutrient solution inside a hydroponic cultivation container in view of the type of plant and growth conditions. In the conventional hydroponic cultivation apparatus, the water level of nutrient solution inside the hydroponic cultivation container is adjusted with a nutrient solution supply controller or a water level sensor attached to a nutrient solution supply unit. However, such a conventional water level adjustment method has a problem that a large-scale apparatus is required. Further, the hydroponic cultivation apparatus described in Patent Document 1 has a problem that, once the U-shaped gutters are installed, it is troublesome and laborious to change the inclination angle of the aligned U-shaped gutters and the shape of the overflow prevention plate.

The present invention has been made in view of the above problems, and the purpose of the present invention is to provide a hydroponic cultivation container, a hydroponic cultivation cover and a hydroponic cultivation apparatus, each of which has a simple structure, and is easy to manufacture, easy to handle, and easy to be altered in its configuration, and to provide a hydroponic cultivation method using such a hydroponic cultivation apparatus.

### Means to Solve the Problems

The hydroponic cultivation container of the present invention is a hydroponic cultivation container, which has outdoor weatherability, and comprises a hollow tube having at least one opening formed in its peripheral wall, through which opening a plant rhizosphere is allowed to be disposed in a hollow portion of the hollow tube.

In the hydroponic cultivation container of the present invention, the hollow tube may be formed of a resin, which may be polyvinyl chloride.

The hydroponic cultivation container of the present invention may further comprises a cylindrical pot having a closed bottom, wherein the pot is held in the hollow portion with its upper end hooked on a periphery of the opening, and may have pores formed in its side wall portion and its bottom portion.

The hydroponic cultivation cover of the present invention is a hydroponic cultivation cover which is used for covering a rhizosphere of a plant being cultivated by hydroponics, and comprises a sheet having outdoor weatherability and flexibility, wherein the sheet has, at its middle portion, a stem penetration perforation having a diameter larger than a diameter of the stem and a notch or cut line extending from the stem penetration perforation to a peripheral edge of the sheet.

The hydroponic cultivation cover of the present invention may have at least one pair of magnets provided on both sides and in the vicinity of the notch or cut line on the surfaces of the sheet, such that the at least one pair of magnets allows portions of the sheets on both sides of the notch or cut line to be held in contact with each other while overlapping each other.

The hydroponic cultivation cover of the present invention is a hydroponic cultivation cover which is used for covering a rhizosphere of a plant being cultivated by hydroponics, and comprises: a first member having outdoor weather resistance and flexibility and being attachable to a peripheral wall of a hydroponic cultivation container for accommodating the plant therein; a second member having outdoor weather resistance and flexibility and being attachable to a peripheral wall of the hydroponic cultivation container; the first member having a first connecting portion for connecting with the second member, the second member having a second connecting portion for connecting with the first member, wherein a notch is formed in each of the first connecting portion and the second connecting portion, and the first member and the second member are connected to each other at the first connecting portion and the second connecting portion, such that the notch of the first connecting portion and the notch of the second connecting portion cooperate to form a stem penetration hole having a diameter larger than a diameter of a stem of the plant.

The hydroponic cultivation cover of the present invention may be formed so as to be in contact with the peripheral wall at the connecting portions of the first member and the second member.

The hydroponic cultivation cover of the present invention may be configured such that a part of the cover is to be in contact with the peripheral wall portion, while the remaining portion of the cover is not to be in contact with the peripheral wall portion.

The hydroponic cultivation cover of the present invention may have at least one pair of magnets provided on the first connecting portion and the second connecting portion, such that the at least one pair of magnets allows the first connecting portion and the second connecting portion to be held in contact with each other while overlapping each other by magnetic force.

The hydroponic cultivation apparatus of the present invention comprises: the aforementioned hydroponic cultivation container; the aforementioned hydroponic cultivation cover; and a nutrient solution supply unit for supplying a nutrient solution to the hollow portion, wherein the hydroponic cultivation cover has a size such that the hydroponic cultivation cover is allowed to cover the opening of the hydroponic cultivation container.

The hydroponic cultivation apparatus of the present invention may further comprises a water level adjuster capable of adjusting a water level of the nutrient solution in the hollow portion, wherein the water level adjustor is connectable to the hydroponic cultivation container.

In the hydroponic cultivation apparatus of the present invention, the water level adjuster may include a joint connected to the hollow tube, wherein the joint has an inlet and an outlet having a smaller diameter than the inlet, the tube is connected to the inlet, the outlet is provided at a position eccentric with respect to the inlet, and the joint is rotatable with its rotation axis coinciding with a central axis of the hollow tube.

In the hydroponic cultivation apparatus of the present invention, the water level adjuster may include a joint connected to the tube, wherein the joint has an inlet and an outlet, the tube is connected to the inlet, and an openable partition plate is provided at the outlet.

In the hydroponic cultivation apparatus of the present invention, the partition plate may be configured to be movable upward and downward.

The hydroponic cultivation apparatus of the present invention may have a configuration wherein the water level adjuster is composed of a joint connected to the tube, the joint has an inlet and a plurality of outlets each having a smaller diameter than the inlet, the tube is connected to the inlet, and each of the outlets is provided at a position eccentric to the inlet and is closable and openable.

The hydroponic cultivation method of the present invention is a method using the aforementioned hydroponic cultivation apparatus, the method comprising: a container disposing step of disposing the hydroponic cultivation container at a predetermined position; a planting step of inserting a rhizosphere of a plant into the hydroponic cultivation container through the opening; a cover installing step of installing the hydroponic cultivation cover on the hydroponic cultivation container such that the hydroponic cultivation cover covers the opening of the hydroponic cultivation container while allowing a stem of the plant to penetrate through the stem penetration hole; and a nutrient solution supplying step of supplying a nutrient solution into the hydroponic cultivation container by the nutrient solution supply unit.

The hydroponic cultivation method of the present invention is a method using the aforementioned hydroponic cultivation apparatus, the method comprising: a container disposing step of disposing the hydroponic cultivation container at a predetermined position; a planting step of inserting a rhizosphere of a plant into the hydroponic cultivation container through the opening; a cover installing step of installing the hydroponic cultivation cover on the hydroponic cultivation container such that the hydroponic cultivation cover covers the opening of the hydroponic cultivation container while allowing a stem of the plant to penetrate through the stem penetration hole; a nutrient solution supplying step of supplying a nutrient solution into the hydroponic cultivation container by the nutrient solution supply unit; and a water level adjusting step of adjusting a water level of the nutrient solution in the hollow portion of the hydroponic cultivation container by the water level adjuster.

In the hydroponic cultivation method of the present invention, the container disposing step may be performed outdoors.

### Effect of the Invention

The present invention can provide a hydroponic cultivation container, a hydroponic cultivation cover and a hydroponic cultivation apparatus, each of which has a simple structure, and is easy to manufacture, easy to handle, and easy to be altered in its configuration, and provide a hydroponic cultivation method using such a hydroponic cultivation apparatus.

### BRIEF DESCRIPTION OF THE DRAWINGS

FIG. 1 is a sectional side view showing a configuration of a hydroponic cultivation apparatus according to a first embodiment of the present invention.

FIG. 2 is a perspective view of a sheet before assembled into a hydroponic cultivation cover used in the hydroponic cultivation apparatus of FIG. 1.

FIG. 3 is a perspective view of a hydroponic cultivation cover assembled from the sheet of FIG. 2.

FIG. 4 is a sectional side view of a water level adjuster used in the hydroponic cultivation apparatus of FIG. 1.

FIG. 5 is a sectional view of the water level adjuster as viewed from the arrow direction of the Q-Q line of FIG. 4.

FIG. 6 is a sectional view of the water level adjuster as viewed from the arrow direction of the Q-Q line of FIG. 4.

FIG. 7 is a cross-sectional view of the water level adjuster as viewed from the arrow direction of the Q-Q line of FIG. 4.

FIG. 8 is a perspective view of a first member and a second member of a hydroponic cultivation cover used in a hydroponic cultivation apparatus according to a second embodiment of the present invention.

FIG. 9 is a perspective view of a hydroponic cultivation cover assembled by combining the first member and the second member of FIG. 8.

FIG. 10 is a perspective view of a first member and a second member of a hydroponic cultivation cover used in a hydroponic cultivation apparatus according to a first modified example of the second embodiment of the present invention.

FIG. 11 is a perspective view of a hydroponic cultivation cover assembled by combining the first member and the second member of FIG. 10.

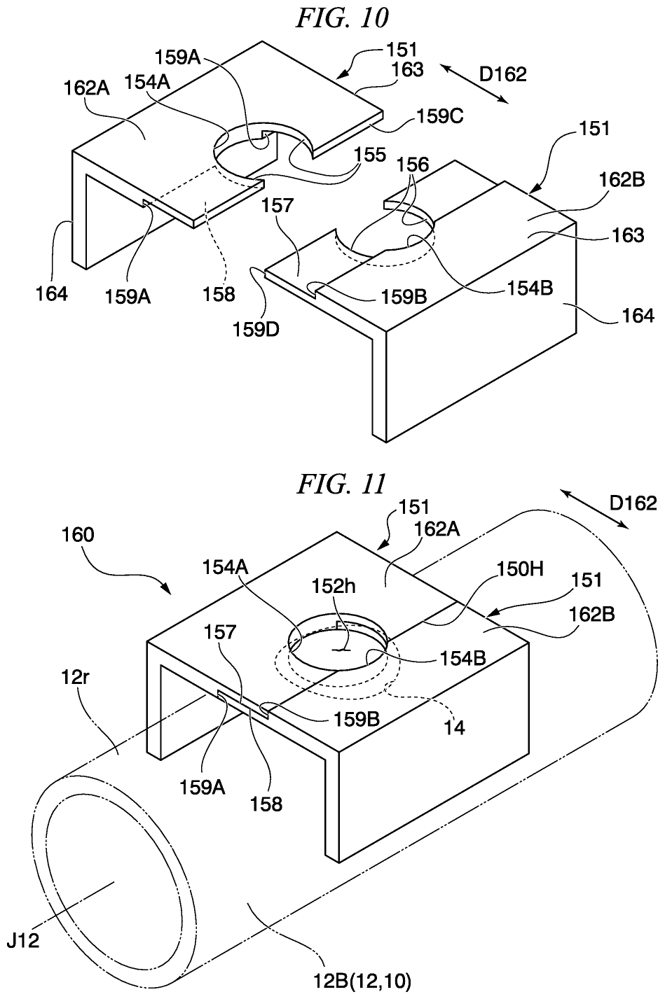

FIG. 10 is a perspective view of a first member and a second member of a hydroponic cultivation cover used in a hydroponic cultivation apparatus according to a second modified example of the second embodiment of the present invention.

FIG. 12 is a perspective view of a hydroponic cultivation cover assembled by combining the first member and the second member of FIG. 12.

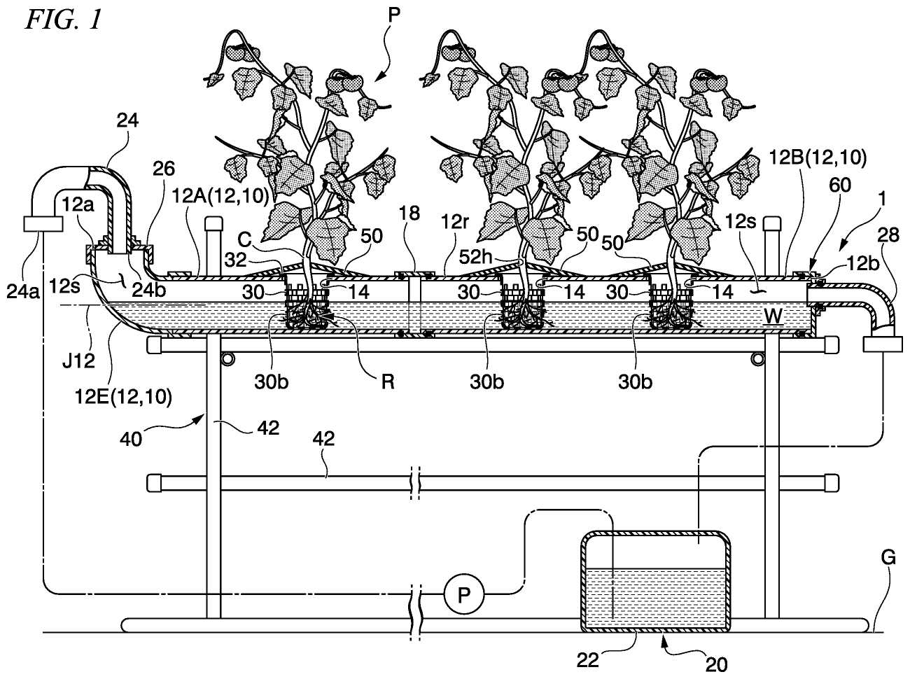

FIG. 14 is a sectional side view of a first modified example of a water level adjuster used in the hydroponic cultivation apparatus of FIG. 1.

FIG. 15 is a sectional side view of a second modified example of a water level adjuster used in the hydroponic cultivation apparatus of FIG. 1.

### DESCRIPTION OF THE EMBODIMENTS

Hereinbelow, the hydroponic cultivation container, hydroponic cultivation cover, hydroponic cultivation apparatus and hydroponic cultivation method of the present invention are described with reference to the drawings. The drawings used in the following descriptions are schematic. The ratios between lengths, widths and thicknesses of each component, etc. shown in the drawings do not necessarily reflect those in the actual products. In addition, the materials and the like exemplified in the following descriptions are merely examples, and the present invention is not limited thereto. The contents described below can be appropriately changed as long as the gist of the present invention is not altered.

### First Embodiment

### [Hydroponic Cultivation Apparatus]

As shown in FIG. 1, the hydroponic cultivation apparatus 1 according to a first embodiment of the present invention includes a container (hydroponic cultivation container) 10, a nutrient solution supply unit 20, a cover (hydroponic cultivation cover) 50, a pot 30, and a water level adjuster 60. The nutrient solution supply unit 20 supplies the nutrient solution W to the hollow portion 12s of the container 10. The cover 50 covers and protects the rhizosphere R of the plant P disposed in the hollow portion 12s. The pot 30 is disposed in the hollow portion 12s. The water level adjuster 60 enables adjustment of the water level of the nutrient solution W in the hollow portion 12s.

The plant P grown in the hydroponic cultivation apparatus 1 is, for example, tomato, but is not particularly limited thereto as long as the plant can be hydroponically grown.

### <Hydroponic Cultivation Container>

The container 10 has a hollow portion 12s, and at least a part of the container 10 is formed in a tubular shape. The container 10 of the present embodiment is composed of a tube (hollow tube) 12.

The tube 12 is composed of an elbow 12E and two tube parts 12A, 12B extending substantially in parallel in the horizontal direction. The two tube parts 12A, 12B are connected by a joint 18. The elbow 12E bends substantially vertically (upward in FIG. 1) from the direction along the axis J12 of the tube parts 12A, 12B. Therefore, the upstream end 12a of the elbow 12E (that is, upstream end 12a of the pipe 12) is oriented in a direction orthogonal to the axis J12. On the other hand, the upstream end of the tube part 12A is inserted into the socket at the downstream end of the elbow 12E. The downstream end 12b of the tube part 12B is oriented in a direction along the axis J12 of the pipe 12.

The inner diameter of the tube 12 is not particularly limited, and can be appropriately set according to the type of the plant to be cultivated. For example, the inner diameter of the tube 12 is preferably 20 mm to 300 mm, more preferably 40 mm to 150 mm, and even more preferably 50 mm to 100 mm. When the inner diameter of the pipe 12 is not less than the above lower limit value, a space of sufficient volume for the growth of roots can be secured, which is advantageous for the growth of the plant. When the inner diameter of the pipe 12 is not more than the upper limit value, it is possible to prevent the materials of the container 10 from becoming too heavy, whereby the ease of installation of the container 10 can be secured.

The thickness of the peripheral wall of the tube 12 is not particularly limited, but is preferably 1 mm to 10 mm, more preferably 2 mm to 7 mm, and still more preferably 2 mm to 5 mm. When the thickness of the peripheral wall of the tube 12 is not less than the lower limit value, the tube 12 can favorably maintain its shape during the cultivation. When the thickness is not more than the upper limit value, it is possible to prevent the materials of the tube 12 from becoming too heavy, whereby the ease of installation of the container can be secured.

Hereinbelow, in the present specification, the tube parts 12A, 12B and the elbow 12E are distinguished from each other and described separately only when necessary. Otherwise, the tube parts 12A, 12B and the elbow 12 E are collectively described as the tube 12.

The nutrient solution W circulates in the hollow portion 12s. Openings 14 are formed in the peripheral wall 12r of the tube 12. The tube 12 is arranged so that the end portion 12a and the openings 14 are opened upward. The rhizosphere R is disposed in the hollow portion 12s through the opening 14 from the outside of the tube 12. The tube 12 is supported by the support 40 so as to be located at a predetermined height from the floor surface G such as the ground. The support 40 includes a plurality of rod-like members 42 connected in a vertical direction or a horizontal direction. The tube 12 may be installed so as to be in contact with the ground.

The material of the tube 12 is not particularly limited as long as the material has outdoor weatherability. From the viewpoint of reducing the weight of the tube 12, it is preferable that the tube 12 is made of a resin. Preferred examples of the resin constituting the tube 12 include polyvinyl chloride (PVC) and polyethylene (PE). When the pipe 12 is made of the above-mentioned material, the pipe 12 can be easily manufactured, the shape of the pipe 12 can be easily changed, and the cost of the pipe 12 can be reduced.

In the present invention, the “outdoor weatherability” is a resistance against qualitative alteration such as deformation, discoloration or deterioration upon exposure to outdoor environment. Specifically, for example, the outdoor weatherability can be evaluated as follows. A sample tube is irradiated with an open frame carbon arc lamp (sunshine carbon arc lamp) according to JIS K 7350 under the following test conditions: an irradiance of 255 W/m² (300 to 700 nm), a showering of 18 minutes out of 120 minutes, a black panel temperature of 63±3° C., application of an outdoor glass filter, a tank inner temperature of 23° C., and a humidity of 50%. The sample tube after 1500 hours of irradiation with the open frame carbon arc lamp is subjected to a ½ flattening test. A sample tube suffering no crack or fissure as a result of the test can be evaluated as having “outdoor weatherability”. When the lamp used for irradiation is a xenon arc lamp, the test conditions may be as follows: an irradiance of 60 W/m² (300 to 400 nm), a showering of 18 minutes out of 120 minutes, a black panel temperature of 63±3° C., application of an outdoor glass filter, a tank inner temperature of 23° C., and a relative humidity (RH) of 50%.

### <Pot>

The pot 30 is disposed in the hollow portion 12s from the outside of the tube 12, and stabilizes the rhizosphere R in the hollow portion 12s. The pot 30 has a main body 30b which is in the shape of a cylindrical pot having a closed bottom such that the rhizosphere R can be accommodated therein. The body 30b has a diameter that gradually and slightly decreases from top to bottom, and is formed of a plastic or the like. A large number of holes are formed in the side wall and the bottom of the main body 30b. As a result, the roots of the plants P are favorably entangled with the main body 30b, and the nutrient solution W is allowed to easily flow between the outside and the inside of the pot 30.

The pot 30 has a flange 32 extending from the upper end of the main body 30b in a direction away from the center of the upper opening of the main body 30b. With this flange 32, the pot 30 is held in the hollow portion 12s, being hooked on the periphery of the opening 14. The diameter of the opening 14 is larger than the diameter of the upper end of the main body 30b and smaller than the maximum diameter of the flange 32. Therefore, the main body 30b can be easily disposed in the hollow portion 12s by hooking the flange 32 on the tube 12 around the opening 14.

### <Hydroponic Cultivation Cover>

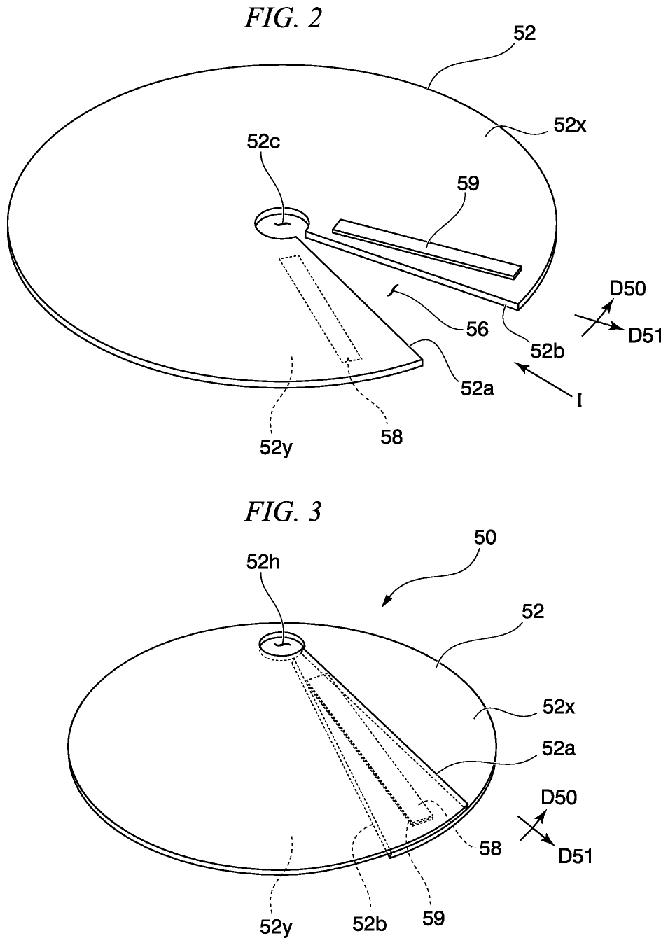

As shown in FIG. 2, the cover 50 according to the first embodiment is composed of a sheet 52 having a substantially circular shape in plan view. At the center of the sheet 52 before assembly, a stem penetration perforation 52c is formed. The diameter of the stem penetration perforation 52c is larger, to an appropriate extent, than the diameter of the stem C (see FIG. 1) of the plant P. The sheet 52 is cut along a radial direction D51 at a predetermined position I in the circumferential direction D50. That is, a notch 56 extending from the stem penetration perforation 52c to the peripheral edge of the sheet 52 is provided at the position I. The width of the notch 56 in the circumferential direction D50 gradually increases as the distance from the communicating portion between the stem penetration perforation 52c and the notch 56 increases in outward radial direction pointed by the arrow D51.

One end 52a of the sheet 52 in the circumferential direction D50 is configured to be detachable from the other end 52b. In the first embodiment, an adhering portion 58 is provided on the back surface 52y in the vicinity of the end 52a of the sheet 52. An adherend portion 59 is provided on the surface 52x in the vicinity of the end 52 b of the sheet 52. The adhering portion 58 and the adherend portion 59 are composed of, for example, magnets which are attachable to each other by magnetic force, magic tapes (registered trademark), etc. For allowing the adhering portion 58 and the adherend portion 59 to be easily attached to each other and easily detached from each other, it is preferable that the adhering portion 58 and the adherend portion 59 are magnets.

The adhering portion 58 and the adherend portion 59 are interchangeable. The adhered portion 59 may be provided on the back surface 52y in the vicinity of the end 52a of the sheet 52. The adhering portion 58 may be provided on the surface 52x in the vicinity of the end 52b of the sheet 52. Further, the adhering portion 58 may be provided on the surface 52x in the vicinity of the end 52a of the sheet 52. The adherend portion 59 may be provided on the back surface 52y in the vicinity of the end 52b of the sheet 52.

As shown in FIG. 3, the adhering portion 58 is adhered to the adherend portion 59, whereby the end 52a overlaps the end 52b of the sheet 52. The disconnected circumference of the stem penetration perforation 52c for stem penetration is connected in the circumferential direction D50 to form a stem penetration hole 52h, thereby assembling the cover 50. The cover 50 descends outward in the radial direction D51 from the stem penetration hole 52 h and has a shape like an umbrella.

As shown in FIG. 1, the cover 50 has a size enough to cover the opening 14. The diameter of the cover 50 in plan view is at least larger than the diameter of the opening 14. The diameter of the sheet 52 shown in FIG. 2 is set to be larger than the diameter in plan view of the cover 50.

The material of the sheet 52 is not particularly limited as long as the material has outdoor weatherability and flexibility. Preferable materials of the sheet 52 are, for example, resins such as synthetic rubbers and polycarbonate (PC).

### <Nutrient Solution Supply Unit>

The nutrient solution supply unit 20 includes a nutrient solution tank 22 capable of storing the nutrient solution W. The pump P is connected to the nutrient solution tank 22. A downstream end 24a of the nutrient solution supply pipe 24 is connected to the pump P. The diameter (outer diameter in the circumferential direction) of the downstream end 24b of the nutrient solution supply pipe 24 is smaller than the diameter of the end 12a of the tube 12. The end 24b of the nutrient solution supply pipe 24 and the end 12a of the tube 12 are connected by the joint 26 so that the end 24b of the nutrient solution supply pipe 24 is disposed inside the end 12a of the tube 12. Therefore, the nutrient solution W pumped up by the pump P from the nutrient solution tank 22 is supplied to the hollow portion 12s via the nutrient solution supply pipe 24.

Although not shown, at the nutrient solution supply port of the nutrient solution tank 22 or between the nutrient solution tank 22 and the pump P may be provided, for example, a filter for removing unnecessary components included in the nutrient solution W, a device for removing unnecessary components, or a nutrient addition device for adding nutrients or the like to promote the growth of the plant P.

### <Water Level Adjuster>

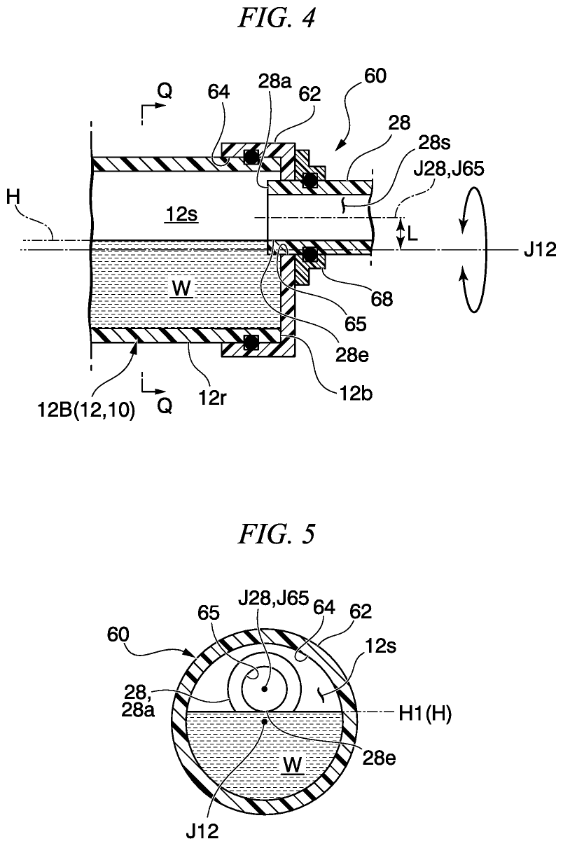

As shown in FIG. 4, the water level adjuster 60 is connected to the end 12b of the tube 12 (that is, the end 12b on the downstream side of the tube 12B). The water level adjuster 60 includes a joint 62 connected to the end 12b.

The joint 62 has an inlet 64 and an outlet 65 having a smaller diameter than the inlet 64. The end 12b of the tube 12 is fitted in the inlet 64. An end 28a on the upstream side of the nutrient solution drainage pipe 28 described later is fitted in the outlet 65 via the seal 68. That is, the end 28a of the nutrient solution drainage pipe 28 is disposed inside the end 12b of the tube 12 via the joint 62.

The outlet 65 is provided eccentrically with respect to the inlet 64 and is rotatable along the inside of the inlet 64. The joint 62 is rotatable around the axis J12 while abutting against the outer surface of the peripheral wall 12r of the tube 12. As the joint 62 rotates around the axis J12, the distance L in the vertical direction between the axis J65 of the outlet 65 or the axis J28 of the nutrient solution drainage pipe 28 and the axis J12 of the tube 12 changes. As the distance L changes, the amount of nutrient solution W discharged from the hollow portion 12s to the hollow portion 28s of the nutrient solution discharge pipe 28 changes in response to the change of distance L.

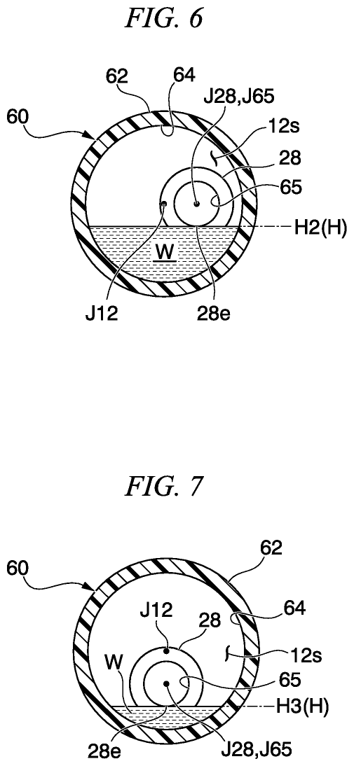

Specifically, as the joint 62 rotates around the axis J12, the water level H of the nutrient solution W in the hollow portion 12s changes as shown in FIGS. 4 to 7. The water level H is adjusted to the same height H1, H2, H3 as the height of the lower end 28e of the hollow portion 28s. As shown in FIG. 5, when the lower end 28e is positioned above the axis J12 when viewed from the upstream side along the axis J12, the water level H1 of the nutrient solution W is adjusted to be positioned above the axis J12. At this time, the amount of nutrient solution W in the hollow portion 12s is larger than when the axes J12, J28, J65 are at the same height. As shown in FIG. 6, when the axes J12, J28, J65 are at the same height and the lower end 28e is positioned below the axis J12, the water level H2 of the nutrient solution W is adjusted to be positioned slightly below the axis J12. At this time, the amount of nutrient solution W in the hollow portion 12s is reduced as compared to the case shown in FIG. 5. As shown in FIG. 7, when the lower end 28e is located at still lower position below the axis J12 as compared to the position shown in FIG. 6, the water level H3 of the nutrient solution W is adjusted to still lower position below the axis J12. At this time, the amount of nutrient solution W in the hollow portion 12s further decreases as compared to the case shown in FIG. 6.

### <Nutrient Solution Drainage Pipe>

As shown in FIG. 1, a downstream end 28b of the nutrient solution drainage pipe 28 is connected to the nutrient solution tank 22 via a connecting pipe or the like (not shown). The nutrient solution W discharged to the hollow portion 28s returns to the nutrient solution tank 22 and can be reused.

### [Hydroponic Cultivation Method]

Next, the hydroponic cultivation method of the first embodiment of the present invention will be described. The hydroponic cultivation method of the first embodiment is a method using the hydroponic cultivation apparatus 1, and includes a container disposing step, a planting step, a cover installing step, a nutrient solution supplying step, and a water level adjusting step. Each step will be described below.

### <Container Disposing Step>

In this step, the tube 12 constituting the container 10 is disposed at a predetermined outdoor location. Specifically, the support 40 is assembled at the predetermined location, and the tube 12 is disposed so as to be supported by the support 40 with the opening 14 facing upward. As shown in FIG. 1, the nutrient solution supply unit 20 and the nutrient solution supply pipe 24 are connected to the end 12a of the tube 12, while the nutrient solution drainage pipe 28 is connected to the end 12b.

### <Planting Step>

In this step, the rhizosphere R of the plant P is put into the hollow portion 12s of the tube 12 located outdoors through the opening 14. Specifically, first, the pot 30 is placed in the hollow portion 12s by attaching the flange 32 to the opening 14 by passing the main body 30b of the pot 30 from its bottom through the opening 14. Subsequently, the rhizosphere R is placed in the pot 30.

### <Cover Installing Step>

In this step, at an outdoor location, the stem C is inserted through the stem penetration hole 52h (stem penetration perforation 52c), and the cover 50 is installed on the container 10 so as to cover the opening 14. First, the stem C is inserted through the stem penetration perforation 52c. Thereafter, the end 52a and the end 52b are bonded, and the opening 14 and the rhizosphere R exposed at the opening 14 are covered with the cover 50. Alternatively, the stem C may be inserted through the stem penetration hole 52h in advance before placing the rhizosphere R in the pot 30. After the end 52a and the end 52b are bonded to assemble the cover 50, the rhizosphere R may be put in the pot 30, and at the same time, the opening 14 and the rhizosphere R exposed at the opening 14 may be covered with the cover 50.

### <Nutrient Solution Supplying Step>

In this step, a predetermined amount of nutrient solution W is supplied outdoors to the hollow portion 12s by the nutrient solution supply unit 20. Specifically, the pump P is operated to supply the nutrient solution W to the hollow portion 12s through the nutrient solution supply pipe 24 at a predetermined flow rate.

### <Water Level Adjusting Step>

Basically, hydroponics is carried out by performing up to the above-mentioned nutrient solution supplying step. Furthermore, the water level H of the nutrient solution W in the hollow portion 12s of the tube 12 may be adjusted outdoors by using the water level adjuster 60 according to the growth state of the plant P or the like. Specifically, the water level H can be adjusted by rotating the joint 62 around the axis J12.

By carrying out the above steps, the hydroponic cultivation cultivation of the plant P using the hydroponic cultivation apparatus 1 can be performed.

### [Effect of First Embodiment]

The container 10 of the first embodiment has weatherability and, hence, would not be deformed nor deteriorated by ultraviolet rays or the like even if installed outdoors. In addition, the length of the container 10 can be set at or altered to a desired length due to the use of tube 12. In other words, by appropriately cutting the tube 12 or freely combining a plurality of tubes 12, the entire shape and configuration of the container 10 can be flexibly changed.

The container 10 is made of resin and, hence, it is light in weight. As a result, a person who performs hydroponics can easily transports the container 10, and handling of the container 10 becomes easy. By constructing the container 10 with polyvinyl chloride, the molding technique for which has been established, the container 10 can be manufactured easily and at low cost.

The container 10 has an opening(s) 14 and includes a pot(s) 30. Therefore, by disposing the rhizosphere R inside the main body 30b, the plant P can be easily planted and the rhizosphere R can be stabilized in the hollow portion 12s. Also, when the rhizosphere R is withdrawn from inside of the main body 30b or the pot 30 containing the rhizosphere R is withdrawn from the container 10, the plant P can be easily removed form or replaced in the container 10.

According to the cover 50 of the first embodiment, when the rhizosphere R is placed at the opening 14, the stem C above the rhizosphere R is passed through the stem penetration hole 52h/stem penetration perforation 52c. By bonding the end 52a to the end 52b of the sheet 52, the cover 50 can be easily installed above the opening 14 without damaging the stem. Further, since the outer diameter of the sheet 52 is larger than the outer diameter of the opening 14 and the cover 50 has such a size that the cover 50 can close the opening 14, the opening 14 can be surely covered without leaving a gap. As a result, the rhizosphere R exposed at the opening 14 can be surely protected. Further, the cover 50 having weatherability can shield the rhizosphere R from light, and prevent rainwater, earth, other contaminants, dirt, etc. from entering the rhizosphere R.

In addition, the hydroponic cultivation container, the hydroponic cultivation cover, the hydroponic cultivation apparatus and the hydroponic cultivation method according to the present invention can be applied to the plant cultivation using microorganisms. In such a case, even when plants are grown outdoors, the cover 50 can shield the rhizosphere from ultraviolet rays or suppress contamination with harmful substances contained in the surrounding soil or rainwater. Therefore, stable outdoor cultivation can be performed for a long term while preventing the microorganisms from being killed by ultraviolet rays or harmful substances. Here, there is no particular limitation on the above microorganisms, and for example, microorganisms known to establish beneficial symbiotic relationships with plants to be cultivated can be used.

The cover 50 of the first embodiment can be easily assembled by bonding the end 52a and the end 52b of the sheet 52 after allowing the stem C to penetrate through the stem penetration hole 52h, and is installed above the opening 14. The stem penetration hole 52h of the sheet 52 enables installation of the cover 50 on the container 10 without damaging the stem C and the like of the plant P. For removing the cover 50, the end 52a and the end 52b of the sheet 52 may be separated from each other to free the stein C from the stein penetration perforation 52c. Thus, handling of the cover 50 is simple. Further, by freely changing the shape of the sheet 52 before assembly, the shape of the cover 50 can be flexibly changed.

In the cover 50, a magnet (adhering portion 58) is provided on the back surface 52y in the vicinity of the end 52a of the sheet 52, and a magnet (adherend portion 59) is provided on the upper surface 52x in the vicinity of the end 52b of the sheet 52. Therefore, the end 52a and the end 52b can be easily attached and detached with simple operation. This makes it easier to handle the cover 50.

The hydroponic cultivation apparatus 1 according to the first embodiment includes a container 10, a cover 50, and a nutrient solution supply unit 20. The hydroponic cultivation apparatus 1 has weatherability, thereby preventing deformation and deterioration of the container 10 and the cover 50 due to weather and the like, and can be used outdoors for a long period of time. Further, for carrying out hydroponics with the hydroponic cultivation apparatus 1, the container 10 is fabricated by a simple operation, the plant P is planted in the container 10, and the cover 50 is installed to protect the rhizosphere R exposed at the opening 14, whereafter the hydroponic cultivation cultivation of the plant P can be almost automatically carried out by operating the pump P. That is, the hydroponic cultivation cultivation can be easily performed with simple operation. Since the configuration of the container 10 can be easily changed as described above, the arrangement of the plants P and the flow path of the nutrient solution W can be flexibly changed. For example, by increasing the number of joints 18 connecting a plurality of tubes 12 to each other and connecting the tubes 12 using the joints 18 so as to form a desired overall shape and pattern, the shape and configuration of the container 10 of the hydroponic cultivation apparatus 1 can be easily changed.

The hydroponic cultivation apparatus 1 can supply the nutrient solution W to the hollow portion 12s via the nutrient solution supply unit 20 and allow the nutrient solution W to be absorbed by plants from the rhizosphere R disposed in the hollow portion 12s. Therefore, the hydroponic cultivation apparatus 1 can be installed outdoors, and the plant P can be hydroponically grown outdoors.

In the hydroponic cultivation apparatus 1, when the water level adjuster 60 is connected to the tube 12, the water level H of the nutrient solution W in the hollow portion 12s can be easily adjusted by using the water level adjuster 60 while suppressing the increase in size of the apparatus.

Further, when the water level adjuster 60 of the first embodiment is used, the lower the position of center of the outlet 65 below the center of the inlet 64, the lower the water level H of the nutrient solution W supplied to the hollow portion 12s. Conversely, the higher the position of center of the outlet 65 above the center of the inlet 64, the higher the water level H of the nutrient solution W supplied to the hollow portion 12s. That is, by rotating the joint 62 around the axis of the tube 12 (rotating the inlet 64 around the axis J12 of the tube 12), the position of the outlet 65 circulate around the axis of the tube 12, so that the height of the outlet 65 changes. That is, by simply moving the center of the outlet 65 relative to the center of the inlet 64, the water level H of the nutrient solution W in the hollow portion 12s can be easily adjusted.

Further, the hydroponic cultivation apparatus 1 is composed of lightweight components, easy to handle, and does not require soil, so that the hydroponic cultivation can be easily carried out at various places including desert areas, underground sites, building roofs and the like without any substantial limitation.

The hydroponic cultivation method according to the first embodiment is a method using the hydroponic cultivation apparatus 1, the method comprising: a container disposing step of disposing the hydroponic cultivation container 10 at a predetermined position; a planting step of inserting a rhizosphere R of a plant into (the hollow portion 12s of) the hydroponic cultivation container 10 through the opening 14; a cover installing step of installing the hydroponic cultivation cover 50 on the hydroponic cultivation container 10 such that the hydroponic cultivation cover 50 covers the opening 14 of the hydroponic cultivation container 10 while allowing a stem C of the plant to penetrate through the stem penetration hole 12h; and a nutrient solution supplying step of supplying a nutrient solution W into the hydroponic cultivation container 10 by a nutrient solution supply unit 20.

According to the above hydroponic cultivation method, the rhizosphere R is inserted through the opening 14, the stem C is allowed to penetrate through the stem penetration hole 12h, and the end 52a and the end 52b of the sheet 52 are bonded to each other, whereby the cover 50 can be easily installed above the opening 14, and the opening 14 and the rhizosphere R can be surely covered with the cover 50.

The hydroponic cultivation method of the first embodiment further includes a water level adjusting step of adjusting a water level H of the nutrient solution W in the hollow portion 12s of the hydroponic cultivation container by the water level adjuster 60. With the use of the water level adjuster 60, the water level H of the nutrient solution W in the hollow portion 12s of the tube 12 can be easily adjusted with simple operation while constantly keeping the supply amount of the nutrient solution W supplied to the hollow portion 12s of the tube 12 by pumping up from the nutrient solution supply unit 20, even without using a control mechanism having a complex configuration or an expensive adjustment mechanism.

Further, in the above hydroponic cultivation method, while supplying a predetermined amount of nutrient solution W to the hollow portion 12s by the nutrient solution supply unit 20, the water level H of the nutrient solution W in the hollow portion 12s can be controlled by using the water level adjuster 60. Furthermore, the water level H of the nutrient solution W in the hollow portion 12s can be easily adjusted while keeping the supply amount of the nutrient solution W from the nutrient solution supply unit 20 at a predetermined level.

### Second Embodiment

### [Hydroponic Cultivation Apparatus]

The hydroponic cultivation apparatus (not shown) according to the second embodiment of the present invention has the same configuration as the hydroponic cultivation apparatus 1 except that a cover 150 shown in FIG. 9 is used in place of the cover 50 of the hydroponic cultivation apparatus 1 of FIG. 1. In the following explanation and the drawings of the hydroponic cultivation apparatus of the second embodiment and the cover 150, the same components as in the hydroponic cultivation apparatus 1 and the cover 50 are referred to with the same reference numerals, and the explanation thereof will be omitted.

The cover 150 includes a first member 152A and a second member 152B connectable to the first member 152A. The first member 152A and the second member 152B are formed of a sheet 151 having outdoor weatherability and flexibility. The first member 152A and the second member 152B can be attached to the peripheral wall 12r of the tube 12 (that is, the container 10). In the second embodiment, the first member 152A and the second member 152B are formed so as to be in contact with the peripheral wall 12r along the direction D152 (direction of coupling between the first member and the second member). When viewed from the upstream side along the axis J12 of the tube 12, the first member 152A and the second member 152B are curved so as to follow the outer surface of the peripheral wall 12r above the axis J12.

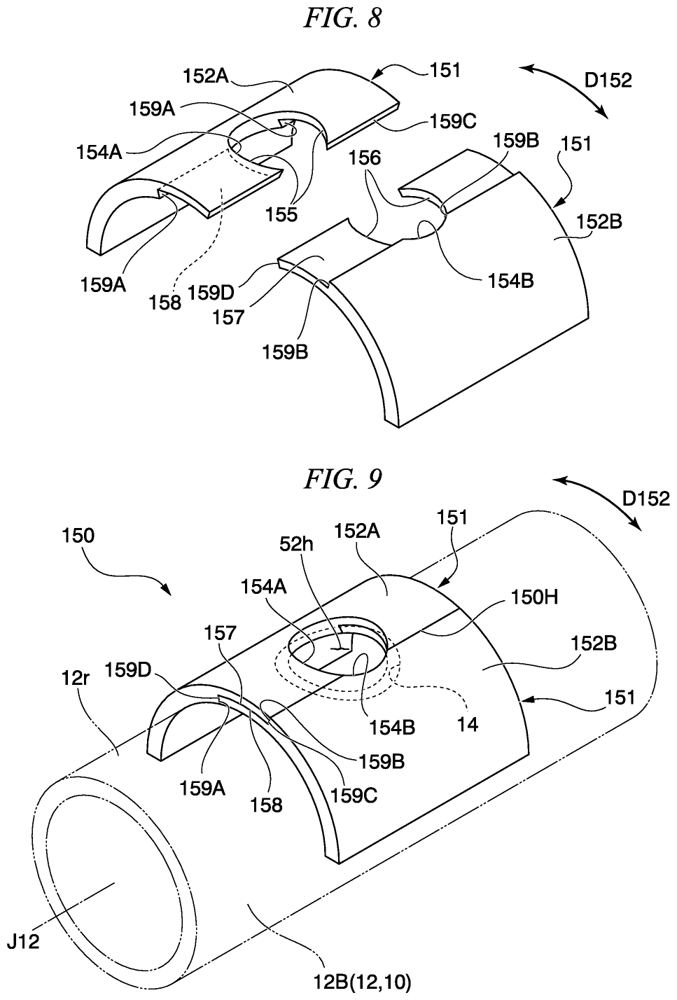

The first member 152A and the second member 152B are connectable along the axis J12 at the upper end portion of the peripheral wall 12r. As shown in FIG. 8, the stem penetration perforation 154A is formed in the first connecting portion 155 of the first member 152A on the side of the second member 152B. The stem penetration perforation 154B is formed in the second connecting portion 156 of the second member 152B on the side of the first member 152A. Each of the stem penetration perforations 154A, 154B has such a size that allows penetration of the stem C of the plant P, and is formed in a substantially circular shape or a semicircular shape in plan view. The stem penetration perforation 154A is opened in the connecting end surface 159C of the first member 152A on the side of the second member 152B. The stem penetration perforation 154B is opened in the connecting end surface 159D of the second member 152B on the side of the first member 152A.

The first member 152A and the second member 152B may be formed of a sheet of the same sheet material or sheets of different materials.

In the second embodiment, the lower side portion of the first connecting portion 155 is cut away, while the upper side portion of the second connecting portion 156 is cut away. As shown in FIG. 9, the second connecting portion 156 fits the lower side of the first connecting portion 155. One of the adhering portion 58 and the adherend portion 59 (not shown) is provided on the lower surface 158 of the first connecting portion 155. And the other one of the adhering portion 58 and the adherend 59 is provided on the upper surface 157 of the second connecting portion 156. As in the first embodiment, the adhering portion 58 and the adhered portion 59 are composed of, for example, magnets or magic tapes (registered trademark) which are attachable to and detachable from each other. For allowing the adhering portion 58 and the adherend portion 59 to be easily attached to each other and easily detached from each other, it is preferable that the adhering portion 58 and the adherend portion 59 are magnets.

When the second connecting portion 156 is fitted to the lower side of the first connecting portion 155, the connecting end surface 159C is attached to the connecting end surface 159B, and the connecting end surface 159D is attached to the connecting end surface 159A. Further, the stein penetration perforation 154A and the stem penetration perforation 154B are arranged so as to overlap with each other, whereby the stem penetration hole 52h is formed. In FIG. 9, the pot 30, the adhering portion 58 and the adherend portion 59 are omitted.

The method of connecting the first member 152A and the second member 152B is not limited to that described above. The method is not particularly limited as long as the connection between the first member 152A and the second member 152B can be stabilized, and the first member 152A and the second member 152B are not easily disconnected. For example, one of the adhering portion 58 and the adherend portion 59 may not be on the lower surface 158 of the first connecting portion 155, and the other one of the adhering portion 58 and the adherend portion 59 may not be on the upper surface 157 of the second connecting portion 156. The second connecting portion 156 may be fitted to the lower side of the first connecting portion 155 and a tape may be attached to the joint 150H between the first member 152A and the second member 152B which are in the coupled state. Alternatively, the first member 152A and the second member 152B in the coupled state may be fixed from the outside with a rubber, a tape, a cord or the like along the coupling direction. Further, the lower side portion of the first connection part 155 and the upper side portion of the second connection part 156 may not be cut away, so that the connecting end surface 159C and the connecting end surface 159A are on the same plane. The connecting end surface 159D and the connection end surface 159B may also be on the same plane. In this case, it is preferable that one of the adhering portion 58 and the adherend portion 59 is provided on one of the connecting end surfaces 159C and 159D. Further, it is preferable that the other one of the adhering portion 58 and the adherend portion 59 is provided on the other one of the connecting end surfaces 159C and 159D. Furthermore, one of the first member 152A and the second member 152B may have an engaging claw, while the other one of the first member 152A and the second member 152B may have a receiving recess which can receive the engaging claw to establish an engagement between the first member 152A and the second member 152B. In any of the configurations described above, the first member 152A and the second member 152B can be easily connected, and are not easily disconnected.

As shown in FIG. 9, the cover 150 has a size enough to cover the opening 14. The length and the width of the cover 150 in plan view are at least larger than the diameter of the opening 14. The length and width of the first member 152A and the second member 152B shown in FIG. 2 are set depending on the length and the width of the cover 150 in plan view.

The material of the sheet 151 has outdoor weatherability and flexibility. The material of the sheet 151 is not particularly limited as long as the first member 152A and the second member 152B can be easily connected and separated, and are not easily disconnected unintentionally when these two members are in the coupled state. A preferable material of the sheet 52 is a resin material such as PVC, PE and polypropylene (polypropylene: PP).

### [Hydroponic Cultivation Method]

Next, the hydroponic cultivation method of the second embodiment of the present invention will be described. The hydroponic cultivation method of the second embodiment is a method using the hydroponic cultivation apparatus of the second embodiment. As in the first embodiment, the hydroponic cultivation method of the second embodiment includes a container disposing step, a planting step, a cover installing step, a nutrient solution supplying step, and a water level adjusting step. With respect to the container disposing step, the planting step, the nutrient solution supplying step and the water level adjusting step of the second embodiment, entirely the same explanations as made above for the respective steps of the first embodiment apply. Hereinbelow, only the cover installing step of the second embodiment will be described.

### <Cover Installing Step>

In this step, the stem C is allowed to penetrate through the stem penetration hole 52h (the stem penetration perforation 154A or the stem penetration perforation 154B) outdoors, and the cover 150 is installed on the container 10 so as to cover the opening 14 (see FIG. 9). Specifically, the stem C is passed through the stem penetration perforation 154A (or the stem penetration perforation 154B). The first connecting portion 155 and the second connecting portion 156 are connected and fixed to each other to assemble the cover 150. The cover 150 covers the opening 14 and the rhizosphere R exposed at the opening 14. Before placing the rhizosphere R in the pot 30, the stem C may be allowed to penetrate through the stem penetration perforation 154A in advance. Thereafter, the cover 150 may be assembled by connecting and fixing the first connecting portion 155 and the second connecting portion 156. Further, the rhizosphere R may be put in the pot 30, and at the same time, the opening 14 and the rhizosphere R exposed at the opening 14 may be covered with the cover 150.

### [First Modification of Second Embodiment]

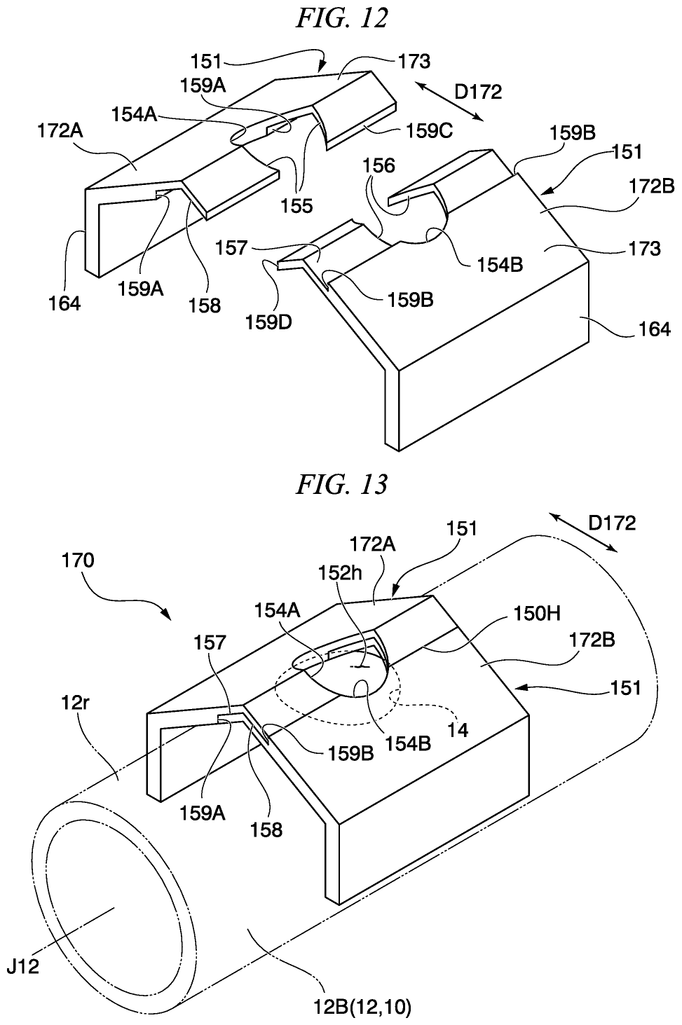

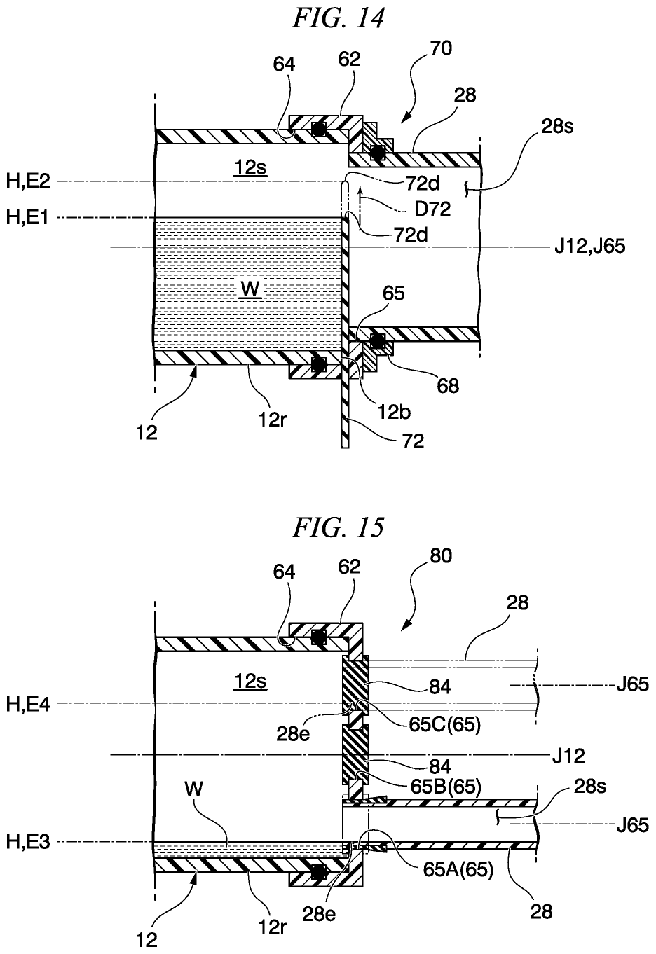

Examples of first modification of the cover 150, the first member 152A and the second member 152B include the cover 160, the first member 162A and the second member 162B which are shown in FIGS. 10 and 11. The first member 162A and the second member 162B are connected along the direction D162 (direction of coupling between the first member and the second member). The direction D162 is a direction of a line extending in contact with the upper end of the tube part 12B in the horizontal plane and orthogonal to the axis J12. Along the peripheral wall 12r, a portion of each of the first member 162A and the second member 162B is in contact with the peripheral wall 12r. The remaining portions of the first member 162A and the second member 162B extend away from the peripheral wall 12r in the radial direction of the pipe part 12B. Each of the first member 162A and the second member 162B of the first modification has an upper surface 163 extending along the direction D162 and a side surface 164 descending from the outer end in the direction D152 of the upper surface 163. The upper surface 163 of the first member 162A is in contact with the upper end of the tube part 12B along the axis J12 at the first connecting portion 155 via the second connecting portion 156. The upper surface 163 of the second member 162B directly contacts the upper end of the tube part 12B along the axis J12 at the second connecting portion 156. The lower portion of the side surface 164 of each of the first member 162A and the second member 162B directly contacts the side of the tube part 12B along the axis J12.

Also in the first modification, when the second connecting portion 156 is fitted to the lower side of the first connecting portion 155 and the adhering portion is adhered to the adherend portion (not shown), the connecting end surface 159C is connected to the connecting end surface 159B and the connecting end surface 159D is connected to the connecting end surface 159A. When the stem penetration perforation 154A and the stem penetration perforation 154B are overlapped to form the stem penetration hole 52h, the assembly of the cover 160 is completed.

### [Second Modification of Second Embodiment]

Examples of the second modification of the cover 150, the first member 152A and the second member 152B include the cover 170, the first member 172A and the second member 172B which are shown in FIGS. 12 and 13. The cover 170 of the second modification has the same configuration as the cover 160. That is, along the peripheral wall 12r, a portion of each of the first member 172A and the second member 172B is in contact with the peripheral wall 12r. The remaining portions of the first member 172A and the second member 172B extend away from the peripheral wall 12r in the radial direction of the pipe part 12B. Each of the first member 162A and the second member 162B of the second modification has an inclined surface 173 and a side surface 164. When viewed from the upstream side along the axis J12, the inclined surface 173 descends from the upper end and the center in the width direction of the pipe part 12B toward the side end of the pipe part 12B. The side surface 164 descends from the outer end in the direction D172 (direction of coupling between the first member and the second member) of the inclined surface 173. Each of the inclined surfaces 173 of the first member 162A and the second member 162B comes into contact with the peripheral wall 12r at a substantially central portion along the direction D172.

Also in the second modification, when the second connecting portion 156 is fitted to the lower side of the first connecting portion 155 and the adhering portion is adhered to the adherend portion (not shown), the connecting end surface 159C is connected to the connecting end surface 159B and the connecting end surface 159D is connected to the connecting end surface 159A. When the stem penetration perforation 154A and the stem penetration perforation 154B are overlapped to form the stem penetration hole 52h, the assembly of the cover 170 is completed. As in the second modification, when the first connecting portion 155 and the second connecting portion 156 are bent to form a chevron shape, the connection strength between the first connecting portion 155 and the second connecting portion 156 is increased.

### [Effect of Second Embodiment and Modification Thereof]

The cover 150 of the second embodiment can be easily assembled by, after passing the stem C through the notch 142A, bonding the first connecting portion 155 and the second connecting portion 156 together to connect the first member 152A and the second member 152B. The thus assembled cover 150 is installed above the opening 14. The cover 150 can be detached by disconnecting the first member 152A from the second member 152B, and freeing the stem C from the notch 142A (or the notch 142B). Thus, handling of the cover 150 is simple. Further, by freely changing the shapes of the first member 152A and the second member 152B, the shape of the cover 50 can be flexibly changed.

In the cover 150, a magnet (adhering portion) is provided on the lower surface 158 of the first connecting portion 155, and another magnet (adherend portion) is provided on the upper surface 157 of the second connecting portion 156. The first connecting portion 155 and the second connecting portion 156 can be easily attached to and detached from each other by a simple operation. This makes it easier to handle the cover 150.

The hydroponic cultivation apparatus of the second embodiment excluding the cover 150 shares the same configuration as the hydroponic cultivation apparatus 1 of the first embodiment excluding the cover 50. Therefore, the hydroponic cultivation apparatus of the second embodiment can enjoy the same effects as the hydroponic cultivation apparatus 1.

The preferred embodiments of the present invention are as described in detail above; however, the present invention is not limited to the specific embodiments, and various modifications and alterations can be made within the gist of the present invention as set forth in the appended claims.

The elbow (L-shaped joint) 12E and the tube parts 12A, 12B may be formed integrally as a single tube. The plurality of tube parts 12A, 12B, . . . may not be linearly connected as illustrated in FIG. 1. For example, the elbow 12E and the tube parts 12A and 12B may be connected in an annular or U shape in plan view. Further, the plurality of tube parts 12A, 12B, . . . may be provided in parallel in the height direction.

The hydroponic cultivation apparatus 1 may not be provided with the nutrient solution tank 22 or the like and may be configured such that sea water or fresh water can be directly introduced into the hydroponic cultivation apparatus 1. Seawater or fresh water drawn for the hydroponic cultivation apparatus 1 may be supplied as the nutrient solution W to the nutrient solution supply pipe 24 and the tube 12. The upstream end 24a of the nutrient solution supply pipe 24 may be connected to a bay, a lake or an underground water-containing layer.

Further, one example of modification of the water level adjuster 60 described in the above embodiment is a water level adjuster 70 as shown in FIG. 14, in which the outlet 65 of the joint 62 does not rotate along the inside of the inlet 64, and which has a partition plate 72 (i.e., a gate valve) provided at the outlet 65.

In the above configuration, the diameter of the outlet 65 need not necessarily be smaller than the diameter of the inlet 64 and may be the same as the diameter of the inlet 64.

In the above configuration, the partition plate 72 is preferably configured to be maneuverable from below the outlet 65 and movable along the vertical direction at the outlet 65 because such configuration allows the water level H of the nutrient solution W to be finely adjusted according to the movement of the partition plate 72. In this instance, by appropriately moving the partition plate 72 in the vertical direction, the water level H of the nutrient solution W can be easily adjusted to a desired water level.

For example, when the upper end 72d of the partition plate 72 is positioned at the height of E1, the water level H of the nutrient solution W becomes the same as the height E1, and when the partition plate 72 is moved in the direction D72 (upward direction) to elevate the upper end 72d to the height E2 as shown by the broken line in FIG. 14, the water level H of the nutrient solution W also rises to the height E2.

The water level adjuster 70 includes a joint 62 connected to the tube 21. The joint 62 includes an inlet 64 and an outlet 65. The tube 12 is connected to the inlet 64, and the partition plate 72 which can be freely opened and closed is provided in the outlet 65. In such a configuration, the size of the outlet 65 changes by opening and closing of the partition plate 72. Therefore, simply by opening and closing the partition plate 72, the water level H of the nutrient solution W in the hollow portion 12s can be easily adjusted.

In the case of the water level adjuster 70, the lowering of the partition plate 72 results in the lowering of the height of the lower end of the outlet 65 through which the nutrient solution W can flow. On the other hand, the rise of the partition plate 72 results in the rise of the height of the lower end of the outlet 65 through which the nutrient solution W can flow, and the rise of the water level H in the hollow portion 12s. Thus, opening and closing the partition plate 72 can change the height of the lower end of the outlet 65 through which the nutrient solution W can flow. Therefore, by opening and closing partition plate 72, the water level H of the nutrient solution W in the hollow portion 12s can be easily adjusted.

Another example of modification of the water level adjuster 60 is a water level adjustment mechanism 80 as shown in FIG. 15, which has a plurality of outlets 65 provided along a predetermined direction relative to the joint 62 (which is not limited as long as it is not left/right or side of the inlet 64 and may be, a circumferential or vertical direction relative to the inlet 64), at least one of which outlets 65 is provided at a position eccentric to the inlet 64 and does not rotate along the inside of the inlet 64, while being openable and closable by a cap 84 or the like. In the above configuration, the number of the outlets 65 is not particularly limited but is, for example, preferably 4 to 5.

The water level adjuster 80 is composed of a joint connected to the tube 12. The joint has an inlet and a plurality of outlets each having a smaller diameter than the inlet. The tube 12 is connected to the inlet, and each of the outlets is provided at a position eccentric to the inlet and is configured to be closable and openable.

In the case of the water level adjuster 80, by appropriately selecting one of the outlets to be opened, the water level H of the nutrient solution W in the hollow portion 12s can be easily adjusted depending on the height of the lower end of the opened outlet. Specifically, a nutrient solution drainage pipe 28 is connected to a desired outlet 65 among the plural outlets 65, while closing other outlets 65 with the caps 84 or the like. As a result, the water level H of the nutrient solution W is changed to the vicinity of the lower end of the outlet 65 connected to the nutrient solution drainage pipe 28. Therefore, by changing the outlet 65 to be connected to the nutrient solution drainage pipe 28, the water level H of the nutrient solution W can be easily changed to a desired water level.

For example, FIG. 15 shows the water level adjuster 80 which has three outlets 65A, 65B, 65C provided along the vertical direction when the points of connection of the joint 62 with the tube 12 and the nutrient solution drainage pipe 28 are viewed sidewise. The outlets 65A and 65C are provided at positions eccentric to the inlet 64, whereas the outlet 65B is provided at a position which is not substantially eccentric to the inlet 64. When the nutrient solution drainage pipe 28 is connected to the outlet 65A formed at the lowest of the outlets and the outlets 65B and 65C are closed by the caps 84, the water level H of the nutrient solution W is equalized to the height E3 (i.e., the height of the lower end 28e of the hollow portion 28s of the nutrient solution drainage pipe 28). On the other hand, as shown by the broken line in FIG. 15, when the nutrient solution drainage pipe 28 is connected to the outlet 65C formed at the highest of the outlets and the outlets 65A, 65B are closed with the caps 84, the water level H of the nutrient solution W rises to E4.

For example, the sheet 52 in the first embodiment may have a cut line communicating with the stem penetration perforation 52c at position I, instead of the notch 56.

### INDUSTRIAL APPLICABILITY

The present invention is widely applicable in the field of hydroponics. Further, the hydroponic cultivation apparatus and the hydroponic cultivation method according to the present invention can be practiced at arbitrary places as long as the supply of a nutrient solution is available even without soil; therefore, the hydroponic cultivation apparatus and the hydroponic cultivation method is applicable to hydroponics carried out at locations such as desert areas, underground sites, etc. where hydroponics was conventionally difficult.

### DESCRIPTION OF THE REFERENCE SIGNS

1 Hydroponic Cultivation apparatus
10 Container (Hydroponic Cultivation Container)
12s Hollow portion
14 Opening
18 Joint
20 Nutrient solution supply unit
30 Pot
50,150,160,170 Cover (Hydroponic cultivation cover)
60,70,80 Water level adjuster
W Nutrient solution
P Plant
R Rhizosphere

1. A hydroponic cultivation container, which has outdoor weatherability, and comprises a hollow tube having at least one opening formed in its peripheral wall, through which opening a plant rhizosphere is allowed to be disposed in a hollow portion of the hollow tube.

2. The hydroponic cultivation container according to claim 1, wherein the hollow tube is formed of a resin.

3. The hydroponic cultivation containing according to claim 2, wherein the resin is polyvinyl chloride.

4. The hydroponic cultivation container according to claim 1, which further comprises a cylindrical pot having a closed bottom, wherein the pot is held in the hollow portion with its upper end hooked on a periphery of the opening, and has pores formed in its side wall portion and its bottom portion.

5. A hydroponic cultivation cover, which is used for covering a rhizosphere of a plant being cultivated by hydroponics, and comprises a sheet having outdoor weatherability and flexibility,
wherein the sheet has, at its middle portion, a stem penetration perforation having a diameter larger than a diameter of the stem and a notch or cut line extending from the stem penetration perforation to a peripheral edge of the sheet.

6. The hydroponic cultivation cover according to claim 5, which has at least one pair of magnets provided at on both sides and in the vicinity of the notch or cut line on the surfaces of the sheet, such that the at least one pair of magnets allows portions of the sheets on both sides of the notch or cut line to be held in contact with each other while overlapping each other.

7. A hydroponic cultivation cover, which is used for covering a rhizosphere of a plant being cultivated by hydroponics, and comprises
a first member having outdoor weather resistance and flexibility and being attachable to a peripheral wall of a hydroponic cultivation container for accommodating the plant therein;
a second member having outdoor weather resistance and flexibility and being attachable to a peripheral wall of the hydroponic cultivation container;
the first member having a first connecting portion for connecting with the second member,
the second member having a second connecting portion for connecting with the first member,
wherein a notch is formed in each of the first connecting portion and the second connecting portion, and the first member and the second member are connected to each other at the first connecting portion and the second connecting portion, such that the notch of the first connecting portion and the notch of the second connecting portion cooperate to form a stem penetration hole having a diameter larger than a diameter of a stem of the plant.

8. The hydroponic cultivation cover according to claim 7, which is formed so as to be in contact with the peripheral wall at the connecting portions of the first member and the second member.

9. The hydroponic cultivation cover according to claim 7, wherein a part of the hydroponic cultivation cover is to be in contact with the peripheral wall portion, while the remaining portion of the hydroponic cultivation cover is not to be in contact with the peripheral wall portion.

10. The hydroponic cultivation cover according to claim 7, which has at least one pair of magnets provided on the first connecting portion and the second connecting portion, such that the at least one pair of magnets allows the first connecting portion and the second connecting portion to be held in contact with each other while overlapping each other by magnetic force.

11. A hydroponic cultivation apparatus, comprising:
a hydroponic cultivation container, which has outdoor weatherability, and comprises a hollow tube having at least one opening formed in its peripheral wall, through which opening a plant rhizosphere is allowed to be disposed in a hollow portion of the hollow tube;
the hydroponic cultivation cover of claim 5; and
a nutrient solution supply unit for supplying a nutrient solution to the hollow portion,
wherein the hydroponic cultivation cover has a size such that the hydroponic cultivation cover is allowed to cover the opening of the hydroponic cultivation container.

12. The hydroponic cultivation apparatus according to claim 11, which further comprises a water level adjuster capable of adjusting a water level of the nutrient solution in the hollow portion, wherein the water level adjustor is connectable to the hydroponic cultivation container.

13. The hydroponic cultivation apparatus according to claim 12, wherein the water level adjuster comprises a joint connected to the hollow tube of the hydroponic cultivation container, wherein:
the joint comprises an inlet and an outlet having a smaller diameter than the inlet,
the hollow tube is connected to the inlet of the joint,
the outlet is provided at a position eccentric with respect to the inlet, and
the joint is rotatable with its rotation axis coinciding with a central axis of the hollow tube.

14. The hydroponic cultivation apparatus according to claim 12, wherein the water level adjuster comprises a joint connected to the hollow tube of the hydroponic cultivation container, wherein:
the joint comprises an inlet and an outlet,
the hollow tube is connected to the inlet of the joint, and
an openable partition plate is provided at the outlet.

15. The hydroponic cultivation apparatus according to claim 14, wherein the partition plate is configured to be movable upward and downward.

16. The hydroponic cultivation apparatus according to claim 12, wherein the water level adjuster comprises a joint connected to the hollow tube of the hydroponic cultivation container, wherein:
the joint comprises an inlet and a plurality of outlets each having a smaller diameter than the inlet,
the hollow tube is connected to the inlet of the joint, and
each of the outlets is closable and provided at a position eccentric with respect to the inlet.

17. A hydroponic cultivation method using the hydroponic cultivation apparatus of claim 11, the method comprising:
a container disposing step of arranging the hydroponic cultivation container at a predetermined position;
a planting step of inserting a rhizosphere of a plant into the hydroponic cultivation container through the opening;
a cover installing step of installing the hydroponic cultivation cover on the hydroponic cultivation container such that the hydroponic cultivation cover covers the opening of the hydroponic cultivation container while allowing a stem of the plant to penetrate through the stem penetration hole;
a nutrient solution supplying step of supplying a nutrient solution into the hydroponic cultivation container by the nutrient solution supply unit.

18. A hydroponic cultivation method using the hydroponic cultivation apparatus of claim 12, the method comprising:
a container disposing step of arranging the hydroponic cultivation container at a predetermined position;
a planting step of inserting a rhizosphere of a plant into the hydroponic cultivation container through the opening;
a cover installing step of installing the hydroponic cultivation cover on the hydroponic cultivation container such that the hydroponic cultivation cover covers the opening of the hydroponic cultivation container while allowing a stem of the plant to penetrate through the stem penetration hole;
a nutrient solution supplying step of supplying a nutrient solution into the hydroponic cultivation container by the nutrient solution supply unit; and
a water level adjusting step of adjusting a water level of the nutrient solution in the hollow portion of the hydroponic cultivation container by the water level adjuster.

19. The method according to claim 17, wherein the container disposing step is performed outdoors.
